(19) United States
(12) Patent Application Publication
(10) Pub. No.: US 2007/0297557 A1
(43) Pub. Date: Dec. 27, 2007

(54) Plant information processing system and plant information processing method

(75) Inventor: Motoichi Kuwatani, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/809,155

(22) Filed: May 31, 2007

(30) Foreign Application Priority Data
Jun. 1, 2006 (JP) 2006-153327

(51) Int. Cl. G21C 17/00

(52) U.S. Cl. 376/259

(57) ABSTRACT

A storage section stores a history of a workflow for a plant in a specific status. A status detection section detects the status of the plant. A search section searches the history of the workflow for the plant that is stored in the storage section when the specific status is detected by the status detection section. A display displays the workflow extracted by the search section. An authority determination section determines whether an operator has an authority for an operation of the workflow extracted by the search section.

This application claims foreign priority based on Japanese Patent application No. 2006-153327, filed Jun. 1, 2006, the content of which is incorporated herein by reference in its entirety.

### BACKGROUND OF THE INVENTION

1. Field of the Invention

The present invention relates to a plant information processing system and a plant information processing method for presenting information for supporting an operation of a plant.

2. Description of the Related Art

A plant information processing system has been known that displays a status of a field device installed in a plant or notifies of an alarm when an abnormality arises in the plant, to monitor the plant and present information for supporting an operation of the plant.

In such a system, an operation available range is previously prescribed on the basis of an authority of an operator from the viewpoint of security. Further, whether the alarm is notified or not notified to the operator is switched in accordance with a monitoring range of the operator.

JP-A-9-196714 discloses an apparatus for managing the history of operation and monitoring of the plant. JP-A-2003-186536 discloses an alarm monitor apparatus for applying a filter to various kinds of alarms generated in a process.

However, in the system of the related art, necessary information cannot be flexibly presented to the operator in accordance with the status of the plant. The operator is referred to, to determine the status of the plant. While the operator determines the status, the operator is forced to select necessary operation on the basis of uniform information, thus the burden of the operator is large. Therefore, it is desired to make a system for supporting the operator, that can present an appropriate operation, without unevenness due to the degree of skill of the operator.

### SUMMARY OF THE INVENTION

The present invention has been made in view of the above circumstances, and provides a plant information processing system and a plant information processing method that can present appropriate information to an operator in accordance with a status of a plant.

In some implementations, a plant information processing system of the invention for presenting information for supporting an operation of a plant, the plant information processing system comprising:

a storage section for storing history of a workflow for the plant in a specific status;

a status detection section for detecting a status of the plant;

a search section for searching the storage section for the history of the workflow for the plant in the specific status when the specific status is detected by the status detection section; and

a display for displaying information on the workflow extracted by the search section.

The plant information processing system further comprising:

an authority determination section for determining whether an operator has an authority for an operation of the workflow extracted by the search section,

wherein the display displays the information on the workflow when the authority determination section determines that the operator has the authority for the operation of the workflow.

In the plant information processing system, the display displays a command for calling the workflow, and displays the workflow when the command is selected.

In some implementations, a plant information processing system of the invention for presenting information for supporting an operation of a plant, the plant information processing system comprising:

a logic storage section for storing a logic for suppressing an alarm in accordance with a status of a facility;

a status detection section for detecting the status of the facility; and

an alarm notification section for notifying a necessary alarm in accordance with a determination based on the logic stored in the logic storage section when a specific status is detected by the status detection section.

The plant information processing system further comprising:

a prescribing section for prescribing a necessity of the notification of the alarm in association with a role of an operator,

wherein the alarm notification section notifies of the alarm to the operator of which role is associated with the necessity of the notification of the alarm prescribed in the prescribing section that the alarm notification is necessary.

In some implementations, a plant information processing method of the invention for presenting information for supporting an operation of a plant, the plant information processing method comprising:

storing history of a workflow for the plant in a specific status;

detecting a status of the plant;

searching the stored history for the history of the workflow of the plant in the specific status when the specific status is detected; and

displaying information on the workflow extracted by the search.

The plant information processing method further comprising:

determining whether an operator has an authority for an operation of the workflow extracted by the search,

wherein the information on the workflow is displayed when it is determined that the operator has the authority for the operation of the workflow.

In the plant information processing method, a command for calling the workflow is displayed, and the workflow is displayed when the command is selected.

In some implementations, a plant information processing method of the invention for presenting information for supporting an operation of a plant, the plant information processing method comprising:

storing a logic for suppressing an alarm in accordance with a status of a facility;

detecting the status of the facility; and

notifying a necessary alarm in accordance with a determination based on the stored logic when a specific status is detected.

The plant information processing system further comprising:

prescribing a necessity of the notification of the alarm in association with a role of an operator,

wherein the alarm is notified to the operator of which role is associated with the necessity of the notification of the alarm prescribed that the alarm notification is necessary.

### BRIEF DESCRIPTION OF THE DRAWINGS

FIG. 1 is a block diagram showing a structure of a plant information processing system according to a first embodiment of the invention.

FIG. 2 is a flowchart showing an operation procedure of the plant information processing system according to the first embodiment.

FIG. 3A is a diagram showing a table held by the plant information processing system, and shows an authority definition table.

FIG. 3B is a diagram showing a table held by the plant information processing system, and shows a menu table.

FIG. 4 shows a diagram illustrating a history table of a workflow stored in a storage section.

FIGS. 5A-5C show diagrams each illustrating a screen display example regarding an operator to whom only an authority for monitoring the current status of the plant is given.

FIGS. 6A-6C show diagrams each illustrating a screen display example regarding an operator having an authority capable of determining the operation of a facility.

FIG. 7 is a block diagram showing a structure of a plant information processing system according to a second embodiment of the invention.

FIG. 8 is a flowchart showing an operation procedure of the plant information processing system according to the second embodiment.

FIG. 9A is a diagram showing a screen display example of a terminal device, and shows the screen display example of a case where an operator is the target of notification of an alarm and it is determined that the alarm notification is necessary.

FIG. 9B is a diagram showing a screen display example of the terminal device, and shows the screen display example of a case where the operator is the target of the alarm notification and it is determined that the alarm notification is unnecessary.

FIG. 9C is a diagram showing a screen display example of the terminal device, and shows the screen display example of a case where the operator is not the target of the alarm notification.

### DESCRIPTION OF THE PREFERRED EMBODIMENTS

Now, embodiments of a plant information processing system according to the present invention will be described below.

### First Embodiment

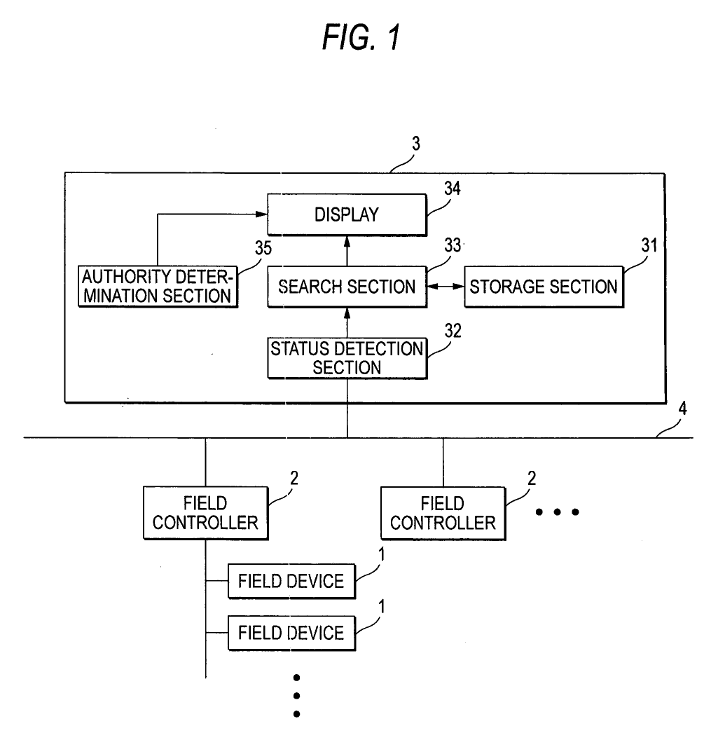

A plant information processing system according to a first embodiment is described by referring to FIGS. 1 to 6C.

FIG. 1 is a block diagram showing a structure of the plant information processing system of this embodiment.

As shown in FIG. 1, the plant information processing system of this embodiment includes field controllers 2 for controlling field devices 1, and a terminal device 3 connected to the field controllers 2 through a communication line 4.

The terminal device 3 includes a storage section 31 for storing a history of a workflow for a plant in a specific status, a status detection section 32 for detecting a status of the plant, a search section 33 for searching the history of the workflow for the plant when the specific status that is stored in the storage section 31 when the specific status is detected by the status detection section 32, a display 34 for displaying the workflow extracted by the search section 33, and an authority determination section 35 for determining whether an operator has an authority of an operation of the workflow extracted by the search section 33.

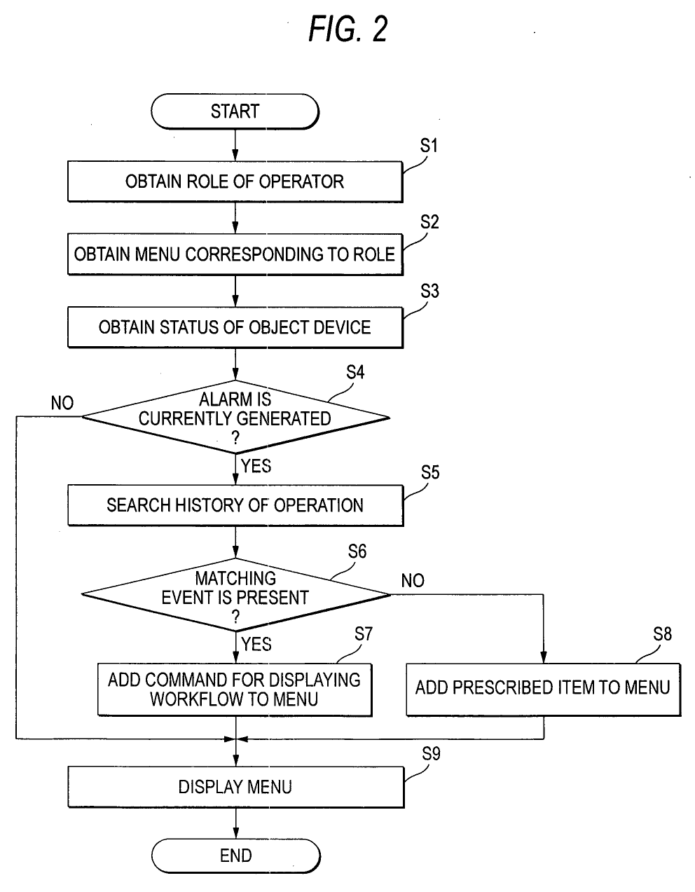

FIG. 2 shows a flowchart illustrating an operation procedure of the plant information processing system of this embodiment.

The operation procedure of FIG. 2 is started by an operation by an operator with respect to the terminal device 3, designating a specific field device 1 as a device to be monitored and operated by the terminal device 3.

In step S1 of FIG. 2, a role of the operator is obtained. The role of the operator is obtained on the basis of a user name verified when the user is verified in the terminal device 3.

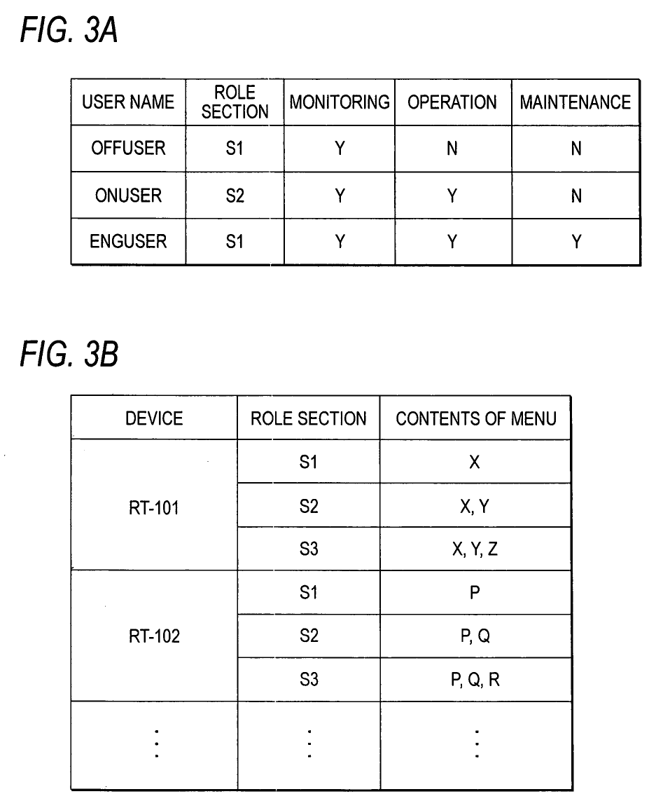

FIG. 3A shows an authority definition table for associating a role with an authority. The authority definition table is stored in the terminal device 3. In the step S1, the role of the operator can be obtained on the basis of the verified user name by using the authority definition table. For instance, when the user name is “OFFUSER”, a role section “S1” is obtained as the role.

Then, in step S2, contents of a menu corresponding to the role of the operator are obtained by using a menu table as the authority determination section 35, which is stored in the terminal device 3. The contents of the menu correspond to the authority of the operator.

FIG. 3B shows the menu table. In the menu table, association of the role section and the contents of the menu is defined for each field device 1. For instance, when the role of the operator is the role section “S1” for the field device designated by a device “RT-101”, the content of the menu is “X”. When the role of the operator is the role section “S2”, the contents of the menu are “X” and “Y”. In the step S2, for instance, when an object device is a device “RT-101” and the role of the operator is the role section “S1”, “X” is obtained as the contents of the menu.

Then, in step S3, the status of the field device 1 as the object device is obtained by using the status detection section 32 through the field controller 2.

Then, in step S4, it is determined whether an alarm is generated for the field device 1 as the object device. When a determination is affirmed, the process goes to step S5. When the determination is negated, the process goes to step S9.

In the step S5, the history of the workflow stored in the storage section 31 is searched by using the search section 33. Here, the workflow for an event corresponding to the currently generated alarm is extracted from a history table.

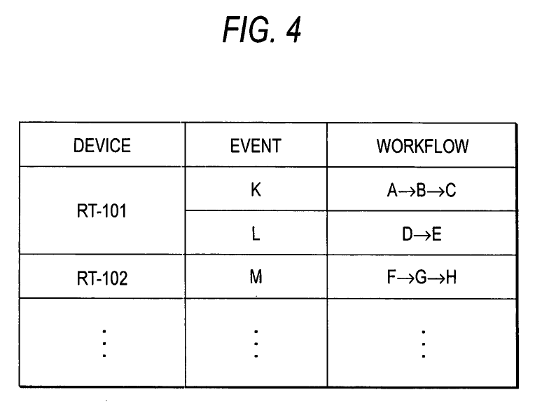

FIG. 4 shows the history table of the workflow stored in the storage section 31. In the history table shown in FIG. 4, an event generated in the past is associated with the workflow after the event arises. For instance, the workflow after the alarm shown by a event “K” is generated for the field device designated by the device “RT-101” is registered as an workflow “A to B to C”.

After that, in step S6, as a result of the search of the history table, it is determined whether the workflow for the event corresponding to the currently generated alarm is registered in the history table. When the determination is affirmed, the process goes to step S7. When the determination is negated, the process goes to step S8.

In the step S7, the workflow extracted from the history table in the step S5 is added to the contents of the menu, and then the process goes to step S9. In the step S7, for instance, the workflow “A to B to C” is added to the contents of the menu.

On the other hand, in the step S8, a prescribed item is added to the contents of the menu, and then the process goes to the step S9.

In the step S9, the display 34 is used to display the contents of the menu on the screen of the terminal device 3 as a pop up menu, and then the process is completed.

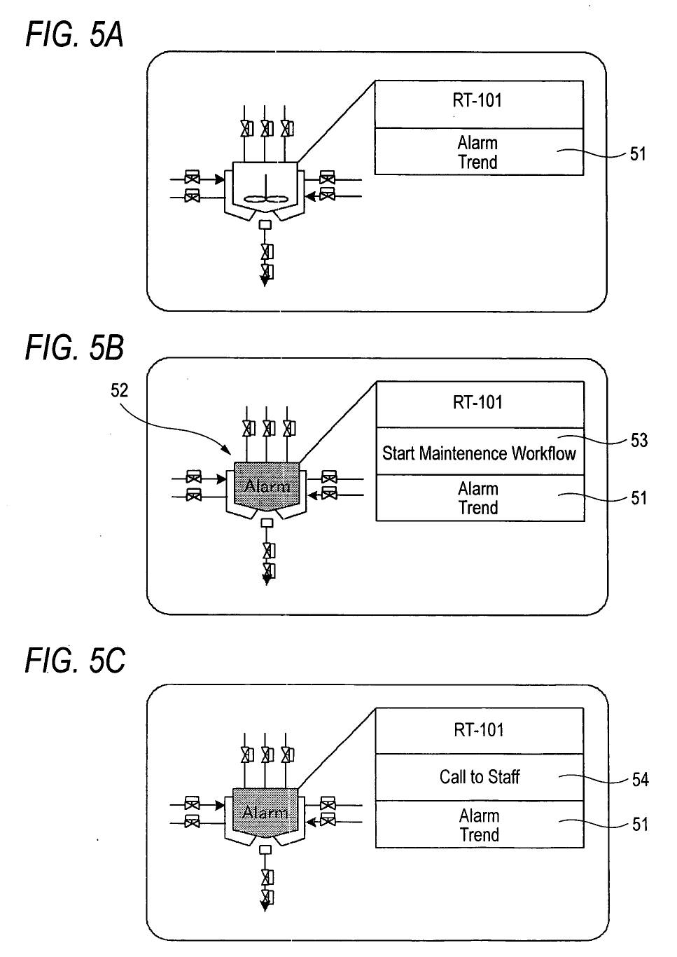

FIGS. 5A-5C show examples displayed on the screen in the step S9, for the operator having only an authority for monitoring the current status of the plant.

FIG. 5A shows a case where the alarm is not generated in the device “RT-101” as the object device (step S4: NO). In the pop up menu, only a command 51 for displaying an alarm history is shown as the contents of the menu. When the command 51 is selected, the alarm history of the device “RT-101” is displayed.

FIG. 5B shows a case where the alarm is generated in the device “RT-101” as the object device and the workflow for the event corresponding to the currently generated alarm is registered in the history table (step S6:YES). In this case, an indication 52 for notifying of the alarm for the device “RT-101” as the object device is added. Further, in the pop up menu, a command 53 for displaying the extracted workflow is displayed in addition to the command 51. When the command 53 is selected, the past workflow for the event corresponding to the alarm currently generated in the device “RT-101” is displayed. Accordingly, when a recovery workflow from a current status is already established and registered in the history table, the operator can carry out a recovery operation in accordance with the displayed workflow.

FIG. 5C shows a case where the alarm is generated in the device “RT-101” as the object device and the workflow for the event corresponding to the currently generated alarm is not registered in the history table (step S6:NO). In this case, the indication 52 for notifying of the alarm for the device “RT-101” as the object device is added. Further, in the pop up menu, a command 54 is displayed in place of the command 53. When the command 54 is selected, a communication procedure to a staff of a higher class about the authority for the device “RT-101” under the current status is displayed.

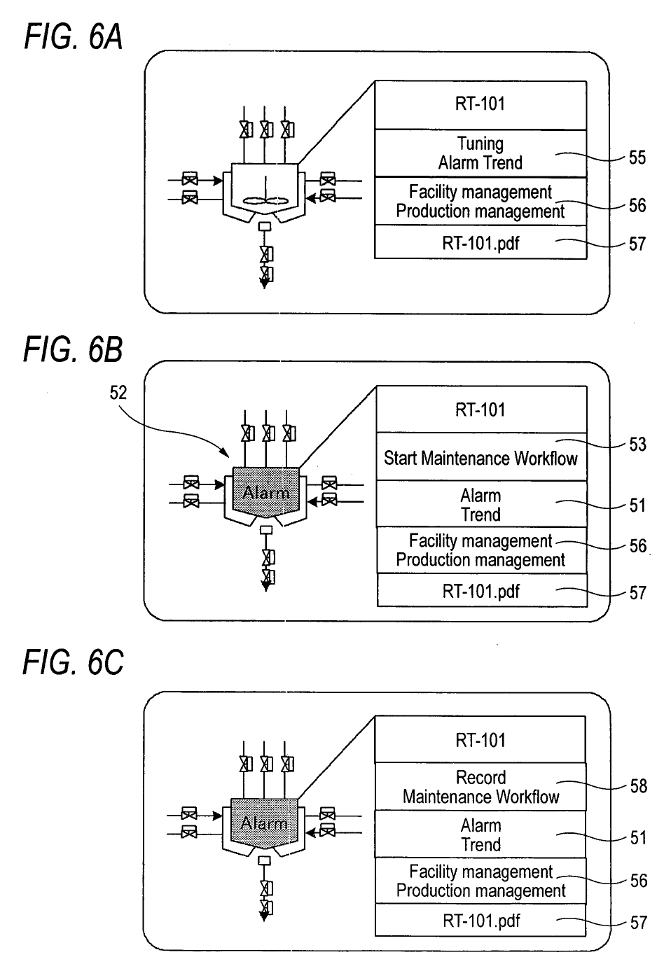

FIGS. 6A-6C show examples displayed on the screen in the step S9, to the operator having an authority capable of determining the operation of a facility as well as changing of setup values (parameters), for the device “RT-101” as the object device.

FIG. 6A shows a case where the alarm is not generated in the device “RT-101” as the object device (step S4: NO). In the pop up menu, displayed are a command 55 for setting the parameter for the alarm with respect to the device “RT-101”, a command 56 for referring to a record such as maintenance and production result of the device “RT-101,” and a command 57 for accessing design information of the device “RT-101”.

FIG. 6B shows a case where the alarm is generated in the device “RT-101” as the object device and the workflow for the event corresponding to the currently generated alarm is registered in the history table (step S6:YES). In this case, the indication 52 for notifying of the alarm for the device “RT-101” as the object device is added. Further, in the pop up menu, the command 53 for displaying the extracted workflow is displayed. When the command 53 is selected similarly to the case shown in FIG. 5B, the past workflow for the event corresponding to the alarm currently generated in the device “RT-101” is displayed. Accordingly, the operator can carry out a recovery operation in accordance with the displayed workflow.

FIG. 6C shows a case where the alarm is generated in the device “RT-101” as the object device and the workflow for the event corresponding to the currently generated alarm is not registered in the history table (step S6:NO). In this case, not the command 53 for displaying the extracted workflow, but a command 58 for registering in the history table a recovery workflow to be carried out is displayed in the pop up menu. When the command 58 is selected, a function of the storage section 31 for storing the recovery workflow is called, and then the workflow of an operation actually carried out by the operator is registered in the history table. Accordingly, when the same event subsequently arises, this workflow can be presented to the operator.

As described above, according to the plant information processing system of this embodiment, necessary information is presented in accordance with the status of the plant and the role of the operator, so that an optimum operation environment can be provided.

In this embodiment, the contents of the menu in the pop up menu are changed depending on the status of the plant or the role of the operator, however, the display of the screen may be switched to a suitable display in accordance with, for instance, the status of the plant. Further, in this embodiment, the workflow stored in the history table is recorded and displayed to the operator. However, a message for explaining the workflow or the main point of the procedure may be recorded as the history of the workflow and displayed depending on the status of the plant, etc. In this case, a user may arbitrarily prepare the message.

### Second Embodiment

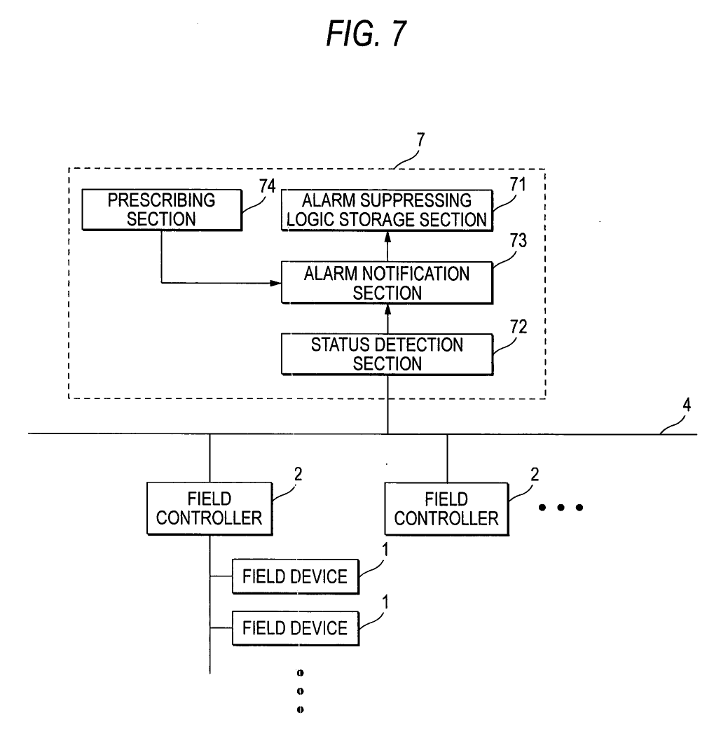

Now, a plant information processing system according to a second embodiment will be described below by referring to FIGS. 7 to 9C.

FIG. 7 is a block diagram showing a structure of the plant information processing system of this embodiment.

As shown in FIG. 7, the plant information processing system of this embodiment includes field controllers 2 for controlling field devices 1, and a terminal device 7 connected to the field controllers 2 through a communication line 4.

The terminal device 7 includes an alarm suppressing logic storage section 71 for storing a logic for suppressing an alarm in accordance with a maintenance status of a facility, a status detection section 72 for detecting the maintenance status of the facility, an alarm notification section 73 for notifying of only a necessary alarm in accordance with a determination based on the logic stored in the logic storage section 71 when a specific maintenance status is detected by the status detection section 72, and a prescribing section 74 for prescribing a necessity of notifying of the alarm in association with the role of an operator.

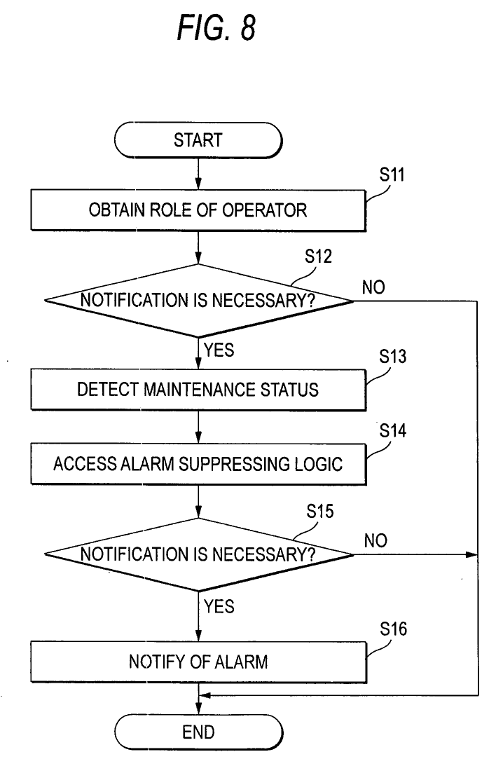

FIG. 8 shows a flowchart illustrating an operation procedure of the plant information processing system of this embodiment. The operation procedure shown in FIG. 8 is started when the alarm is generated in a plant.

In step S11 of FIG. 8, the role of an operator is obtained. The role of the operator is obtained on the basis of the user name verified when the user is verified in the terminal device 7, similarly as in the first embodiment.

Then, in step S12, it is determined whether it is necessary to notify the operator of the generated alarm based on the role of the operator obtained in the step S11, by the prescribing section 74. When the determination is affirmed, the process goes to step S13. When the determination is negated, the process is completed.

In the step S13, the maintenance status in the plant is detected by the status detection section 72. Here, for instance, whether the field device 1 related to the generated alarm is in a status of maintenance is detected through the field controller 2.

Then, in step S14, the logic stored in the alarm suppressing logic storage section 71 is accessed. After that, in step S15, it is determined whether there is a necessity for the alarm notification to the operator on the basis of the logic. When the determination is affirmed, the process goes to step S16. When the determination is negated, the process is completed.

In the step S16, notification of the alarm to the operator is performed by using the alarm notification section 73, and then the process is completed.

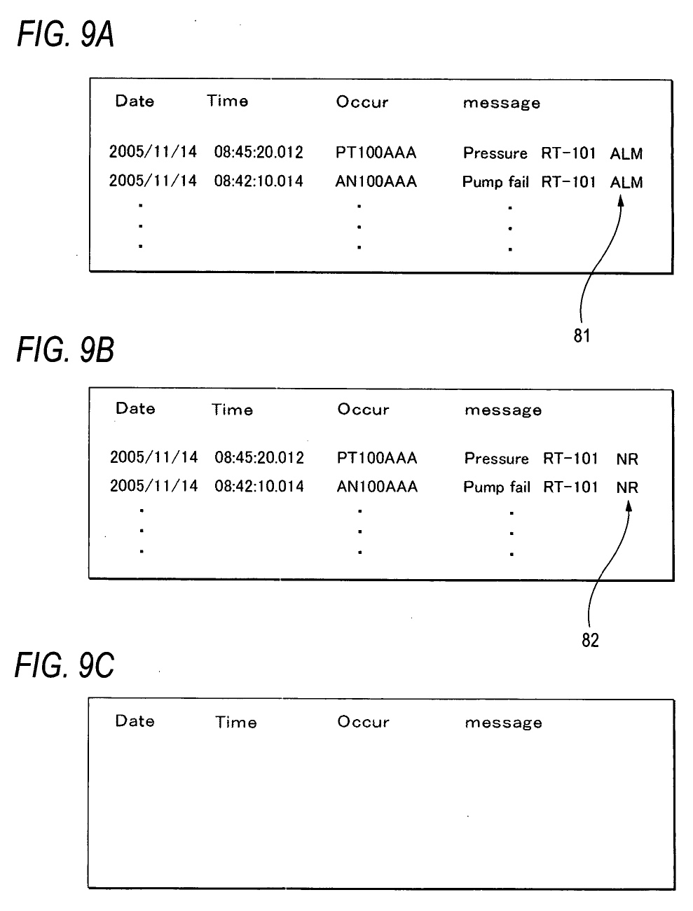

FIGS. 9A-9C are diagrams each showing an example displayed on the screen of the terminal device 7 in accordance with the operation of FIG. 8.

FIG. 9A shows the example displayed on the screen when the operator is a target for the alarm notification in view of the role of the operator (step S12: YES), and it is determined that the alarm notification is necessary in view of the logic stored in the logic storage section 71 (step S15: YES).

In this case, a generated event is displayed on the screen and a character string 81 for notifying of the alarm for the event is displayed. In such a way, during a normal operation when a maintenance related to the corresponding field device 1 is not carried out, the generated event is displayed on the screen and the character string 81 representing the alarm for the event is displayed.

Then, FIG. 9B shows the example displayed on the screen when the operator is the target for the alarm notification in view of the role of the operator (step S12: YES), and it is determined that the alarm notification is not necessary in view of the logic stored in the logic storage section 71 (step S15: NO).

In such a way, when the maintenance related to the corresponding field device 1 is being carried out, the generated event is displayed on the screen, however, a character string 82 representing that the event does not correspond to the alarm and is normal is displayed.

Further, FIG. 9C shows the example displayed on the screen when the operator is not the target for the alarm notification in view of the role of the operator (step S12: NO). In this case, the generated event is not displayed, nor an indication for notifying of the alarm is not displayed.

As described above, according to the plant information processing system of this embodiment, only a necessary alarm notification is performed in accordance with the role of the operator, and an unnecessary alarm notification is suppressed in accordance with the maintenance status of the plant. Accordingly, the operator can be prevented from erroneously recognizing an event generated due to the maintenance as the abnormality of the plant.

In this embodiment, the alarm notification is suppressed depending on the maintenance status. However, for instance, immediately after the plant is activated, the alarm notification can be suppressed. In this case, the abnormality or the variation of parameter values, etc., during an unstable period immediately after the plant is activated is treated such that they are different from the influence of the abnormality originally arises in the plant, so that the unnecessary alarm notification can be suppressed.

As described above, according to the plant information processing system of the present invention, information corresponding to the role of the operator can be presented to the operator from information accumulated in the past, in accordance with the status of the plant changing every moment, or the unnecessary alarm can be suppressed in accordance with the plant status. Therefore, appropriate information can be always given to the operator to flexibly meet the change of the status, and a stable and highly efficient production can be realized.

According to the plant information processing system of the present invention, since the stored history of the workflow for the plant in the specific status is searched and the extracted workflow is displayed, the operator can refer to the displayed workflow to carry out an appropriate operation.

According to the plant information processing system of the present invention, when the specific status is detected, only the necessary alarm is notified in accordance with the determination based on the logic stored the logic storage section, so that an unnecessary alarm is not notified. Thus, an erroneous recognition of the operator can be prevented.

According to the plant information processing method of the present invention, since the stored history of the workflow for the plant in the specific status is searched and the extracted workflow is displayed, the operator can refer to the displayed workflow to carry out an appropriate operation.

According to the plant information processing method of the present invention, when the specific status is detected, only the necessary alarm is notified in accordance with the determination based on the logic stored the logic storage section, so that an unnecessary alarm is not notified. Thus, an erroneous recognition of the operator can be prevented.

An applied range of the present invention is not limited to the above-described embodiments. The present invention can be widely applied to an information processing system and an information processing method for presenting information for supporting an operation of a plant.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

[FIG. 1]
31 storage section
32 status detection section
33 search section
34 display
35 authority determination section
2 field controller
1 field device

[FIG. 2]
S1. Obtain role of operator
S2. Obtain menu corresponding to role
S3. Obtain status of object device
S4. Alarm is currently generated ?
S5. Search history of operation
S6. Matching event is present ?
S7. Add command for displaying workflow to menu
S8. Add prescribed item to menu
S9. Display menu
a start
b end

[FIG. 3A]
A user name
B role section
C monitoring
D operation
E maintenance

[FIG. 3B]
A device
B role section
C contents of menu

[FIG. 4]
A device
B event
C workflow

[FIG. 7]
71 alarm suppressing logic storage section
72 status detection section
73 alarm notification section
74 prescribing section
2 field controller
1 field device

[FIG. 8]
S1. Obtain role of operator
S12. Notification is necessary ?
S13. Detect maintenance status
S14. Access alarm suppressing logic
S15. Notification is necessary ?
S16. Notify of alarm
a start
b end

What is claimed is:

1. A plant information processing system for presenting information for supporting an operation of a plant, the plant information processing system comprising:
a storage section for storing history of a workflow for the plant in a specific status;
a status detection section for detecting a status of the plant;
a search section for searching the storage section for the history of the workflow for the plant in the specific status when the specific status is detected by the status detection section; and
a display for displaying information on the workflow extracted by the search section.

2. The plant information processing system according to claim 1, further comprising:
an authority determination section for determining whether an operator has an authority for an operation of the workflow extracted by the search section,
wherein the display displays the information on the workflow when the authority determination section determines that the operator has the authority for the operation of the workflow.

3. The plant information processing system according to claim 1, wherein the display displays a command for calling the workflow, and displays the workflow when the command is selected.

4. A plant information processing system for presenting information for supporting an operation of a plant, the plant information processing system comprising:
a logic storage section for storing a logic for suppressing an alarm in accordance with a status of a facility;
a status detection section for detecting the status of the facility; and
an alarm notification section for notifying a necessary alarm in accordance with a determination based on the logic stored in the logic storage section when a specific status is detected by the status detection section.

5. The plant information processing system according to claim 4, further comprising:
a prescribing section for prescribing a necessity of the notification of the alarm in association with a role of an operator,
wherein the alarm notification section notifies of the alarm to the operator of which role is associated with the necessity of the notification of the alarm prescribed in the prescribing section that the alarm notification is necessary.

6. A plant information processing method for presenting information for supporting an operation of a plant, the plant information processing method comprising:
storing history of a workflow for the plant in a specific status;
detecting a status of the plant;
searching the stored history for the history of the workflow of the plant in the specific status when the specific status is detected; and
displaying information on the workflow extracted by the search.

7. The plant information processing method according to claim 6, further comprising:
determining whether an operator has an authority for an operation of the workflow extracted by the search,
wherein the information on the workflow is displayed when it is determined that the operator has the authority for the operation of the workflow.

8. The plant information processing method according to claim 6, wherein a command for calling the workflow is displayed, and the workflow is displayed when the command is selected.

9. A plant information processing method for presenting information for supporting an operation of a plant, the plant information processing method comprising:
storing a logic for suppressing an alarm in accordance with a status of a facility;
detecting the status of the facility; and
notifying a necessary alarm in accordance with a determination based on the stored logic when a specific status is detected.

10. The plant information processing system according to claim 9, further comprising:
prescribing a necessity of the notification of the alarm in association with a role of an operator,
wherein the alarm is notified to the operator of which role is associated with the necessity of the notification of the alarm prescribed that the alarm notification is necessary.
